(19) United States
(12) Patent Application Publication
(10) Pub. No.: US 2016/0371781 A1
(43) Pub. Date: Dec. 22, 2016

(54) DATA MANAGEMENT SYSTEM AND METHOD

(71) Applicant: Gerald C. Steffes, Overland Park, KS (US)

(72) Inventor: Gerald C. Steffes, Overland Park, KS (US)

(21) Appl. No.: 15/187,547

(22) Filed: Jun. 20, 2016

Related U.S. Application Data
(60) Provisional application No. 62/181,501, filed on Jun. 18, 2015.

(51) Int. Cl. G06Q 40/06

(52) U.S. Cl. CPC G06Q 40/06

(57) ABSTRACT

A non-emotional system and method for identifying and promptly reacting to macroeconomic and business cycle trends and allocating investment assets accordingly to optimize investment portfolio returns and reduce investment portfolio systematic risk. A preferred embodiment includes a set of indicator signals which tend to indicate and/or respond to recession-like conditions. The indicator signals are based on analysis of multiple known economic data sets. The data sets are manipulated, smoothed, and/or analyzed, and the indicator signals are triggered when certain predetermined patterns within the data occur. In a preferred embodiment, when two or more indicator signals are triggered, pre-recession conditions are determined to exist, and the investment markets are closely monitored. If two or more of the indicator signals are activated and the investment markets trend downward, tactical assets are moved from equity investments to more stable fixed income investments in stages.

### CROSS-REFERENCE TO RELATED APPLICATION

This application claims priority in U.S. Provisional Patent Application No. 62/181,501, filed Jun. 18, 2015, which is incorporated herein by reference.

### BACKGROUND OF THE INVENTION

1. Field of the Invention

The present invention relates generally to the management of data for allocation of investment assets. More specifically, the invention relates to a system for identifying macroeconomic and business cycle trends to optimize an investment portfolio's ongoing asset allocation with the goal of increased long-term performance and reduced investment risk relative to a passive buy and hold strategy.

2. Description of the Related Art

The United States economy continually fluctuates up and down, depending upon many different factors. This process of repeated economic expansion and contraction is commonly referred to as the business cycle. The ultimate goal of investing is to optimize long-term portfolio performance and increase value as much as possible, but changes in the business cycle can make decisions for how to allocate assets very difficult. Investors generally want to “buy low” and “sell high.” However, since the market generally trends upward long term, it is important not to overreact to every drop in the market. The volatility of the market often causes investors to make imprudent, emotional investment decisions in hopes of maximizing their returns and avoiding drops in the investment markets.

Commonly used asset allocation techniques tend to follow two primary strategies: strategic asset allocation and tactical asset allocation.

Strategic asset allocation is the more traditional approach that utilizes the tenants of Modern Portfolio Theory in a passive investment style. With strategic asset allocation, an investor establishes their investment portfolio's strategic allocation and primarily follows a buy and hold strategy. The goal of strategic asset allocation is to create a portfolio based on the investment goals and risk tolerance of the investor. Changes in the investment portfolio allocation among each asset class are usually only made when the portfolio becomes “unbalanced” due to fluctuations in the market or when the investor's risk/reward profile changes.

Tactical asset allocation is a more dynamic investment strategy that actively adjusts a portfolio's asset allocation among various asset classes. The goal of a tactical asset allocation strategy is to improve upon the risk-adjusted returns produced by strategic asset allocation. Tactical asset allocation attempts to add value by overweighting asset classes that are expected to overperform on a relative basis in the near term and underweighting asset classes that are expected to underperform in the near term. Tactical asset allocation typically relies on financial and economic variables or signals used to assign relative short-term asset class weightings. Tactical asset allocation generally focuses on asset classes of stocks, bonds, and cash, but can also include asset classes such as real estate, currencies, commodities, and other alternative investments.

Tactical asset allocation can be generally summarized as relying on one or more of five primary strategies: momentum strategies, fundamental-valuation strategies, the “Fed Model” strategy, sentiment strategies, and macroeconomic and business cycle strategies.

Momentum strategies attempt to add value by following the short-term momentum in markets and/or asset classes. Typical momentum signals include technical indicators, earnings growth, changes in trading volumes, etc.

Fundamental-valuation strategies involve using fundamental firm-valuation metrics, such as dividend yield, book/market ratio, price-earnings (“P/E”) ratio, cash flow valuation, etc.

The Fed Model strategy compares earnings yields (the inverse of the P/E ratio) to nominal bond yields to determine the relative attractiveness of equities over bonds.

Sentiment strategies attempt to add value through a contrarian viewpoint that looks for extreme levels of sentiment, such as consumer confidence and margin borrowing, to identify deviations from equilibrium returns.

Macroeconomic and business cycle strategies attempt to find value by identifying the macroeconomic and business cycle related variations in market risk and valuations.

Investment assets have two primary types of risk: systematic and unsystematic. Systematic risk, also known as market risk or macroeconomic risk, is vulnerability for unanticipated events that affect almost all investments and asset classes, at least to some degree, because of economy-wide effects. Unsystematic risk, also called unique risk or microeconomic risk, is vulnerability for unanticipated events that affect individual investments or individual asset classes. Highly diversified portfolios tend to have very little unsystematic risk. Thus, use of broad market equity funds, such as the S&P 500 Index or total market equity index funds, diversify away most unsystematic risk.

Considering that unsystematic risk can be mostly eliminated by diversification, the “systematic risk principle” states that the reward for bearing risk depends on the level of systematic risk. In investment risk calculations, the level of systematic risk in a particular investment or asset class, relative to an average of similar investments such as a broad market index fund, is given by the Beta coefficient of that investment. Alpha is a measure of performance on a risk-adjusted basis and is the return on an investment that is not the result of the general movement in the greater market it is benchmarked against. A widely recognized model is the “Optimal Risk Portfolio in the Single-Index Model” formula:

E(Rₚ)=E(Rₘ)Bₚ+aₚ

E(Rₚ)=Expected return of the portfolio

E(Rₘ)=Expected return of the market

Bₚ=Beta of the portfolio

aₚ=Alpha of the portfolio

The Alpha for highly diversified index funds tends to be at or very close to zero. So, if the expected return of the equity markets during a recession is negative, then reducing the Beta of the investment portfolio during a recession results in the expected return of the investment portfolio incurring reduced losses relative to the expected losses of the market.

Over time, some of the most dramatic declines in portfolio values have been experienced during economic recessions. So, the ability to identify a recession and to reallocate assets accordingly is very important for minimizing portfolio losses and maximizing portfolio profitability. As a general rule, a recession is a significant decline in economic activity spread across the economy, lasting more than a few months, normally visible in real gross domestic product (GDP), real income, employment, industrial production, and wholesale-retail sales. In the early stages of a recession, shifting tactical assets from equity investments into more stable fixed income or money market investments results in a lower Beta for the overall investment portfolio.

Recessions are determined retroactively by the National Bureau of Economic Research (NBER) rather than in real time. So, by the time a recession has been officially determined by the NBER, significant loss in value of investment portfolios may have already occurred.

There are many known macroeconomic and business cycle trends that are analyzed by financial professionals when attempting to forecast what investment markets will do. While some of these trends can be indicators of a coming or ongoing recession, they each have their issues when looked at individually. For instance, an individual forecaster of economic recession may produce false signals in addition to signaling an actual recession.

One known potential forecaster of economic recessions is an inverted Treasury bonds yield curve. Typically, one-year Treasury bond yields are lower than ten-year Treasury bond yields. When one-year Treasury bond yields become greater than ten-year Treasury bond yields, it is an inversion of the yield curve. As a rule of thumb, an inverted yield curve may indicate a recession within the next 12-18 months. However, this indicator, on its own, can produce false signals. Additionally, government manipulation of Treasury bond yields could potentially impact this pattern.

The Leading Economic Index is produced monthly by the Conference Board, a non-governmental, non-profit business membership and research group organization. The Leading Economic Index takes into account ten economic variables which have historically turned downward before a recession and upward before an expansion. The ten economic variables are average weekly manufacturing hours, average weekly initial claims for unemployment insurance, manufacturers' new orders for consumer goods, ISM new orders index, manufacturers' new nondefense capital goods orders, building permits for new private housing, S&P 500 stock index, Leading Credit Index, interest rate yield curve using the federal funds rate and ten-year Treasury bonds, and consumer sentiment. These indicators tend to shift ahead of the business cycle, so the Leading Economic Index is intended to be a leading indicator of a recession. However, the Leading Economic Index can also produce false signals. Another challenge with the Leading Economic Index data is that revisions are made to the data after its initial release. Therefore, the Leading Economic Index data one sees in real time may be different than the historical data used to develop trading systems.

The Coincident Economic Index is another economic indicator produced by the Conference Board. The Coincident Economic Index is based on four key variables that attempt to measure current economic activity in the business cycle. The four variables taken into account are employees on non-agricultural payrolls, personal income less transfer payments (e.g., Social Security, welfare), industrial production, and manufacturing and trade sales. These indicators are intended to define the business cycle in real time. However, in addition to the potential for false signals, the Coincident Economic Index is revised after initial release in the same manner as the Leading Economic Index.

Employment trends can also be an indicator of a recession. The Bureau of Labor Statistics produces weekly and monthly data on employment and unemployment in the United States. As a general rule, when seasonally adjusted employment rates are decreasing relative to the previous year's seasonally adjusted employment rates, the risk of recession significantly increases. However, using employment information as an economic indicator can produce false signals, and other factors can influence employment trends. Employment statistics are also revised after initial release so the real time data may be different than the historical data used to develop trading systems.

The Chicago Federal Reserve Bank's National Activity Index (CFNAI) is a monthly index that is designed to gauge overall national economic activity. The CFNAI is a weighted average composed of 85 monthly indicators and designed to have an average value of zero. The 85 indicators are drawn from four broad categories of economic data: production and income; employment, unemployment, and hours; personal consumption and housing; and sales, orders, and inventories. A CFNAI value of −0.7 or lower is intended to indicate a strong potential for recession. However, CFNAI data is also subject to revisions after its initial release, and it could produce false signals.

In addition to inversions of the Treasury bond yield curve, the Leading Economic Index, the Coincident Economic Index, employment trends, and the CFNAI, many different economic data sets and indexes are used by economists and financial professionals in attempts to predict recessions and other market trends.

The present invention aims to provide a mathematical, non-emotional system and method for more efficient responses to recession-like economic conditions and to minimize reaction to non-recession economic conditions.

### SUMMARY OF THE INVENTION

The present invention provides a system and method for promptly reacting to economic trends, analyzing whether the trends tend to indicate recession-like conditions, and allocating investment assets accordingly to optimize investment portfolio returns and reduce investment portfolio systematic risk. The present invention is preferably applied to tactical asset allocation having macroeconomic and business cycle strategies. The goal of the current invention is to use historical economic data to identify macroeconomic and business cycle trends preceding or during economic recessions and then reduce the tactical asset allocation in risk assets, such as stocks, in pre-determined stages and increase tactical asset allocation in cash or money market assets. Such tactical asset reallocation preceding or during a recession reduces the investment portfolio's overall systematic risk Beta coefficient, resulting in an increase in the expected return on the investment portfolio relative to the expected return of the market. The invention relies primarily on the use of highly diversified broad market equity funds, such as the S&P 500 Index or total market equity index funds with which the Alpha is at or very close to zero. Therefore, Alpha is not a consideration of the present invention.

The preferred embodiment is aimed towards efficient allocation of tactical assets, however, alternatively, the invention can be modified for reallocating other types of investments. One embodiment of the system includes five indicator signals which tend to indicate and/or respond to recession-like economic conditions. These indicator signals are based upon analysis of five different known economic data sets. The data sets are manipulated, smoothed, and/or analyzed, and the indicator signals are triggered when certain predetermined patterns within the data occur. When two or more indicator signals are triggered, pre-recession conditions are determined to exist, and the S&P 500 Index and/or other broad market equity indexes are closely monitored. If two or more of the indicator signals are activated and the S&P 500 Index (or other broad market equity indexes) trends downward, tactical assets are moved from stocks to more stable fixed income investments such as cash or money market assets in stages. When the market begins trending upward based on pre-determined patterns, the tactical assets are moved back into equity investments in stages. The present invention is designed to take human emotions out of tactical asset allocation decisions.

### BRIEF DESCRIPTION OF THE DRAWINGS

The patent or application file contains at least one drawing executed in color. Copies of this patent or patent application with color drawings will be provided by the Office upon request and payment of the necessary fee.

The drawings constitute a part of this specification and include exemplary embodiments of the present invention illustrating various objects and features thereof.

FIG. 1 shows an illustration of an asset allocation strategy having diversified strategic equity assets, tactical equity assets, and fixed income assets.

FIG. 2 shows United States recession data and corresponding S&P 500 Index data dating back to the 1950s.

FIG. 3a shows a graph of a typical Treasury bond interest rate yield curve with ten-year Treasury bond interest rate yields greater than one-year Treasury bond interest rate yields.

FIG. 3b shows graphs of inverted Treasury bond interest rate yield curves which preceded the last eight recessions.

FIG. 4 shows a graph of ten-year Treasury bond interest rate yields and one-year Treasury bond interest rate yields since 1955. Inversions in the Treasury bond interest rate yields are identified embodying an aspect of the present invention. Corresponding U.S. recession and S&P 500 Index data are included for reference.

FIG. 5 shows a graph of smoothed Leading Economic Index data since 1958 and Leading Economic Index recession-like indicator signal data embodying an aspect of the present invention. Corresponding U.S. recession and S&P 500 Index data are included for reference.

FIG. 6 shows a graph of smoothed employment rate of change data since 1955 and employment rate recession-like indicator signal data embodying an aspect of the present invention. Corresponding U.S. recession and S&P 500 Index data are included for reference.

FIG. 7 shows a graph of smoothed CFNAI data since 1968 and CFNAI recession-like indicator signal data embodying an aspect of the present invention. Corresponding U.S. recession and S&P 500 Index data are included for reference.

FIG. 8 shows a graph of smoothed Coincident Economic Index data since 1958 and Coincident Economic Index recession-like indicator signal data embodying an aspect of the present invention. Corresponding U.S. recession and S&P 500 Index data are included for reference.

FIG. 9 illustrates a tactical asset allocation strategy embodying an aspect of the present invention.

FIGS. 10a-10c show a flowchart illustrating a system and method of allocating tactical investment assets to optimize investment portfolio returns and reduce investment portfolio systematic risk which embodies the present invention.

### DETAILED DESCRIPTION OF THE PREFERRED EMBODIMENTS

### I. Introduction and Environment

As required, detailed aspects of the disclosed subject matter are disclosed herein; however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed form.

### II. Preferred Embodiment

The present invention provides a system and method configured for promptly and accurately responding to economic recession-like conditions and allocating tactical assets accordingly to minimize losses without sacrificing long-term portfolio gains. In a preferred embodiment, during typical non-recession economic conditions, an investment portfolio designed to be 60% equity investments and 40% fixed income investments would be allocated into three distinct groups: 30% strategic equity assets, 30% tactical equity assets, and 40% fixed income. The present invention is utilized for reallocating tactical assets from stocks into fixed income when recession-like conditions exist.

In an exemplary embodiment of the present invention, five known economic data sets historically indicative of recession-like conditions are obtained for analysis of current economic conditions. In the preferred embodiment, United States Treasury Bonds interest rate yield curve data; the Conference Board's Leading Economic Index data; employment trends data; the Chicago Federal Reserve National Activity Index (CFNAI) data; and the Conference Board's Coincident Economic Index data are used. Each of these economic data sets has historically been an individual indicator of recession-like conditions, dating back to the 1950s and 1960s. However, on their own, each economic indicator has some issues, such as the potential for false signals, post-release data revisions, the potential for government manipulation, etc. The present invention utilizes multiple economic data sets in combination to efficiently identify actual recession-like conditions. This combination of data sets helps to minimize false signals. Alternatively, more or less than five economic indicator data sets may be used in the present invention. Additionally, in other embodiments, other economic data, some of the aforementioned data sets, or a combination thereof may be utilized.

Once the economic data sets are obtained, the data is manipulated to put it in better condition to represent actual economic trends and conditions. One such manipulation is smoothing data using moving or rolling averages. Use of moving averages helps to decrease the effect of post-release revisions to the data and to smooth out the data to better illustrate the overall trends. The data is put into graphic form and closely analyzed for trends and determinative factors. Data may be graphed in a computer program such as Microsoft Excel or any other type of graph-producing program. The analysis includes analysis of the depth, duration, and diffusion of trends. Depth means how deep is the change in the economic indicator data. Duration means how long is the change occurring. Diffusion means how many of the individual factors making up the economic indicator are trending in the same direction. An indicator trigger which tends to indicate recession-like conditions is determined for each of the manipulated economic data sets, taking depth, duration, and diffusion into account. The data is then analyzed for the presence of the predetermined indicator triggers.

In a preferred embodiment, the present invention includes an economic alert level system ranging between one and five, with alert level five indicating no recession conditions are evident and alert level one indicating the highest alert level in which recession conditions exist. The alert level system may optionally be color-coded in a similar manner to the U.S. Armed Forces defensive readiness condition (DEFCON) system. In alternative embodiments, level one may be the lowest alert level and level five the highest. A different number of alert levels may also be used.

In this embodiment, when any two or more of the predetermined indicator triggers are triggered, pre-recession conditions are determined to exist and the alert level is moved to four. At this time, the S&P 500 Index is very closely monitored. Two moving averages are used in monitoring the S&P 500 Index, and crossovers of the long and short moving averages are used to determine whether the market is trending upward or downward. In a preferred embodiment, 25-day and 85-day moving averages are used to analyze trends in the S&P 500 Index data. However, the 25-day and 85-day moving averages are not limiting; alternative moving averages may be used instead. Tactical assets are not reallocated from equity investments into fixed income investments until the investment markets actually trend downward because the investment markets can increase for a period of time when recession-like conditions exist. This occurrence is sometimes referred to as the investment markets having “irrational exuberance.”

While at alert level four—with two or more economic indicator triggers met—if the S&P 500 Index trends downward by a predetermined amount, alert level three is triggered. At alert level three, a first third of tactical assets are moved from equity investments into more stable fixed income investments such as cash or money market funds. If the smoothed S&P 500 Index continues to trend downward and the smoothed S&P 500 Index drops an additional 0.5%, the alert level is moved to level two. At alert level two, a second third of tactical assets is moved from equity investments and reallocated into fixed income investments such as cash or money market funds. If the smoothed S&P 500 Index keeps trending down and drops another 0.5%, alert level one is triggered, meaning recession conditions exist. At alert level one, the final third of tactical assets is moved from equity investments and reallocated into fixed income investments such as cash or money market funds.

However, if at any time the smoothed S&P 500 Index trends back upward to a predetermined level, taking the moving averages into account, tactical assets are allocated back into equity investments from fixed income investments such as cash or money market funds. The reallocation of tactical assets into equity investments is conducted in stages, one-third at a time. In alternative embodiments of the present invention, tactical assets may be allocated in different amounts than in thirds and the level of change in the smoothed S&P 500 Index required to move between alert levels may be different. Additionally, alternative broad market index funds other than the S&P 500 Index may be used and monitored to indicate systematic economic market trends. While the S&P 500 Index has historically been a good systematic indicator of economic market trends, past performance does not guarantee future results. The S&P 500 Index is unmanaged and an investment cannot be made directly into an Index.

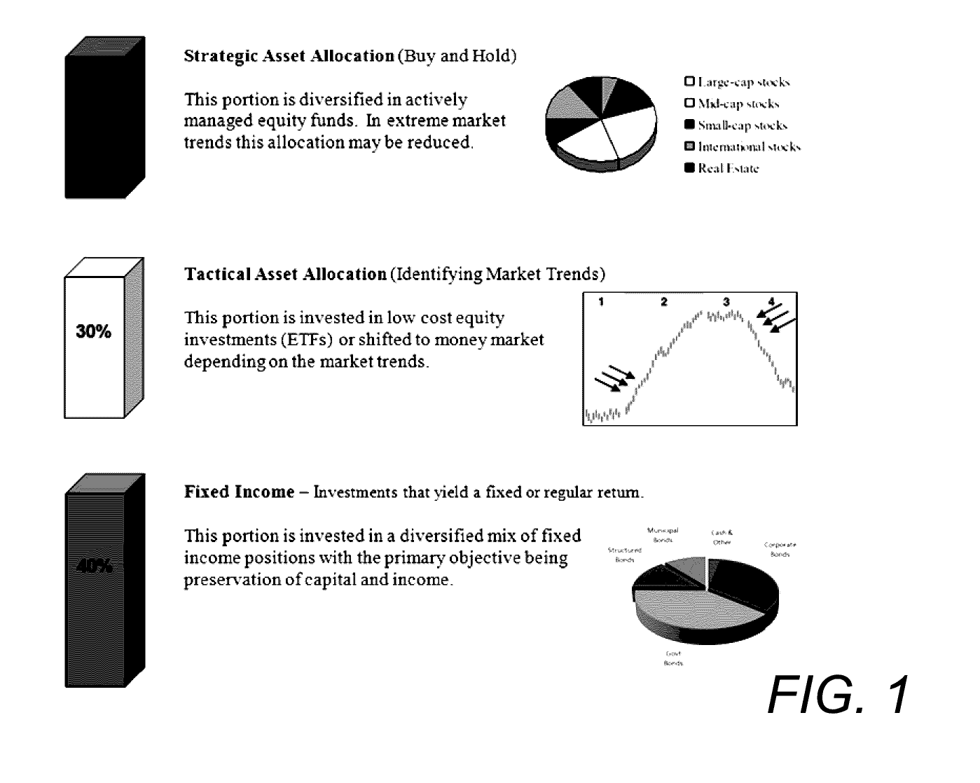

Referring to the drawings in more detail, FIG. 1 illustrates three main investment asset allocation groups. These groups include strategic assets, tactical assets, and fixed income. Strategic asset allocation primarily follows a passive buy and hold investment strategy. Strategic assets are typically diversified in actively managed equity funds based on the investment goals and risk tolerance of the investor. Changes in strategic asset allocation among asset classes are usually only made when the strategic portfolio becomes “unbalanced” from fluctuations in the market or when the investor's risk/reward profile changes. In the embodiment shown in FIG. 1, strategic assets are diversified into large-cap stocks, mid-cap stocks, small-cap stocks, international stocks, and real estate. Alternatively, strategic assets can be diversified into different equity investments.

Tactical asset allocation uses a more dynamic investment strategy which actively adjusts a portfolio's asset allocation among various asset classes. Tactical asset allocation aims to improve upon risk-adjusted returns produced by strategic asset allocations by identifying market trends and overweighting asset classes expected to overperform on a relative basis in the near term and underweighting asset classes expected to underperform on a relative basis in the near term. During non-recession economic conditions, tactical assets are typically invested in equity investments. When there are recession-like conditions, tactical assets are shifted into more stable fixed income investments, such as cash or money market funds. In the embodiment shown in FIG. 1, tactical assets are invested in low cost broad market or index equity investments such as Exchange Traded Funds (ETFs) or is rebalanced into fixed income investments such as cash or money market funds depending on market trends. The present invention optimizes tactical asset allocation between equity and fixed income investments based upon macroeconomic and business cycle indicators.

Fixed income assets are made up of investments that yield a fixed or regular return. This portion of the portfolio is invested in a diversified mix of fixed income positions with the primary objective of preserving capital and income. In the embodiment shown in FIG. 1, fixed income assets are diversified in government bonds, corporate bonds, structured bonds, municipal bonds, cash, and other.

FIG. 1 illustrates asset allocation when no recession conditions are evident. In this embodiment, the assets are distributed as 30% strategic assets, 30% tactical assets, and 40% fixed income when recession conditions do not exist. In alternative embodiments, different base investment allocations may be utilized. When recession-like conditions exist, tactical assets may be reallocated from equity investments into fixed income investments. When recession conditions are evident, the asset allocation would be 30% strategic assets and 70% fixed income. In extreme market trends, strategic assets may also be reduced.

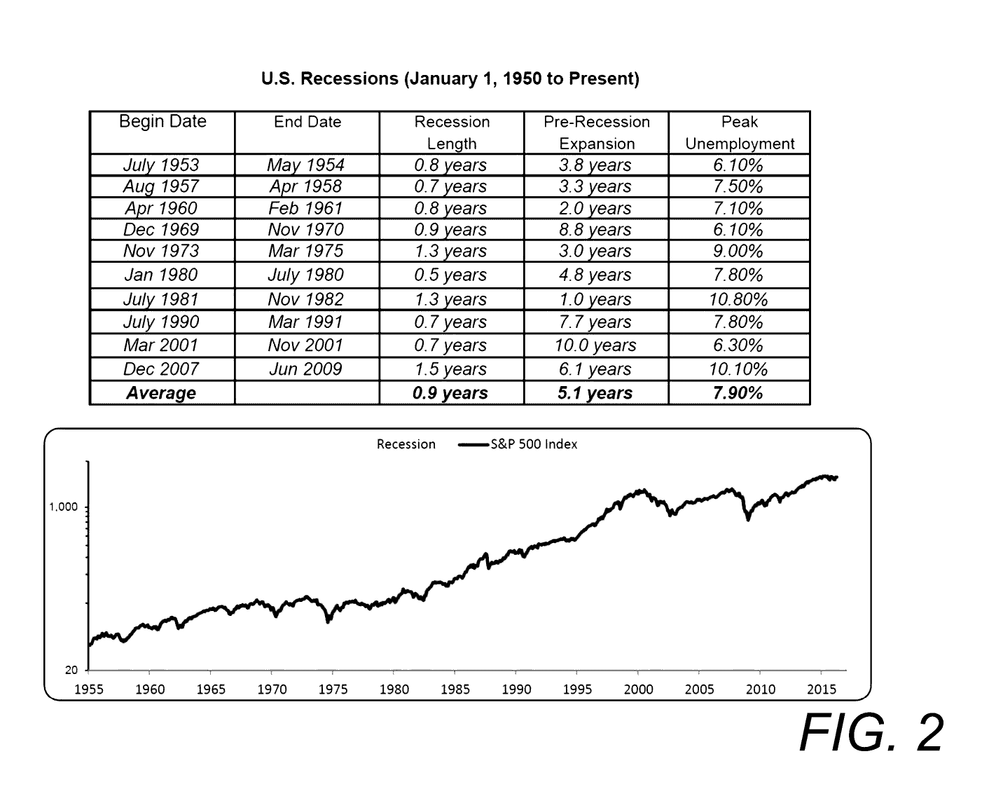

FIG. 2 shows U.S. recession data dating back to Jan. 1, 1950 and the changes in the S&P 500 Index during that time. Shadings on the S&P 500 Index graph signify recessions since 1955. The historical recession data is obtained from the National Bureau of Economic Research (NBER). The data shown in FIG. 2 illustrates the lengths of business cycles since the 1950s including the lengths of recessions and pre-recession expansions of the business cycle. NBER recession data shows that since Jan. 1, 1950, the average recession lasts 0.9 years and the average pre-recession expansion lasts 5.1 years, making the average business cycle about 6 years long. However, the data indicates that the average business cycle since 1990 has been longer than 6 years. For systematic analysis of historic economic market trends, raw data of the S&P 500 Index from the 1950s to the present is obtained and graphed. Recessions are indicated on the S&P 500 Index graph to identify the effect of economic recessions on the investment markets.

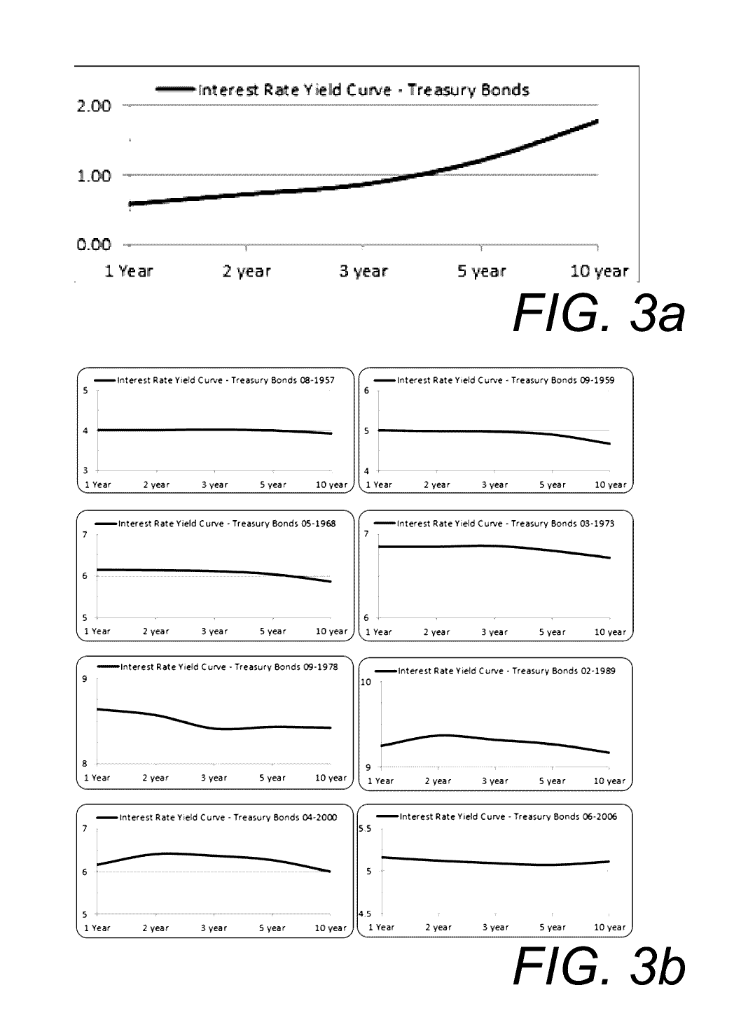

FIG. 3a shows a typical, non-recession Treasury bond interest rate yield curve graph. When recession-like conditions are not evident, ten-year Treasury bonds have interest rate yields greater than one-year Treasury bond interest rate yields. Inversions in the Treasury bond yield curve have historically indicated a recession may occur in the next 12-18 months. FIG. 3b shows previous inversions of the Treasury bond yield curves prior to economic recessions. In each of these instances—August 1957, September 1959, May 1968, March 1973, September 1978, February 1989, April 2000, and June 2006—one-year Treasury bond interest rate yields became greater than ten-year Treasury bond interest rate yields, preceding a recession.

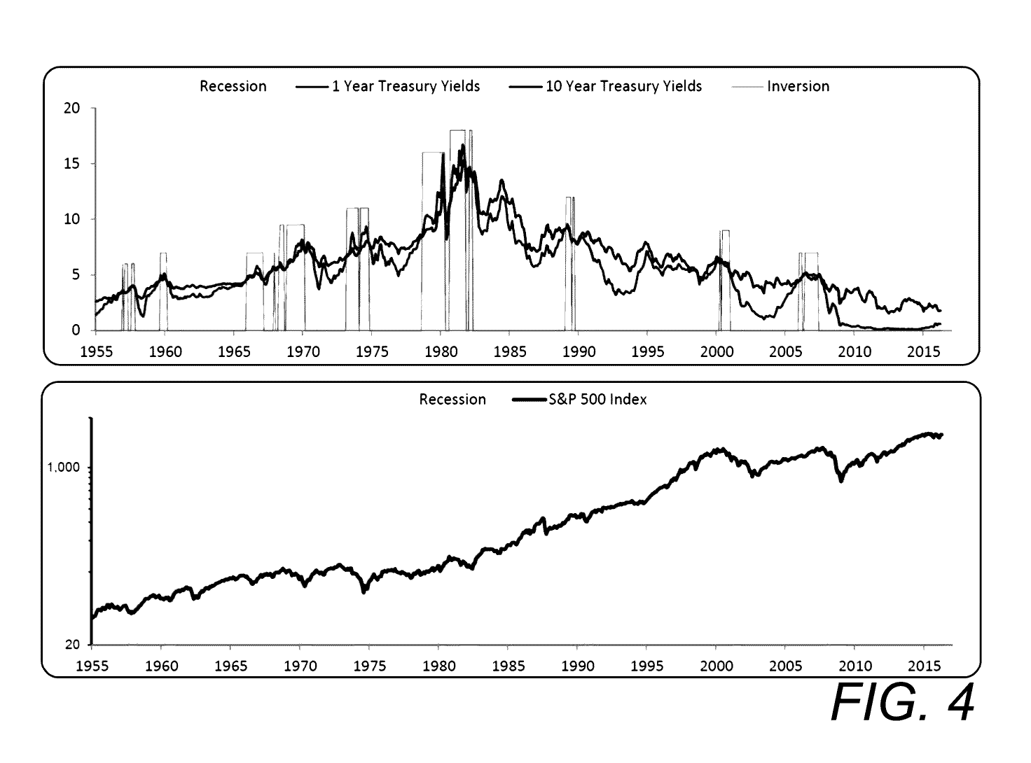

FIG. 4 includes a graph showing one-year Treasury bond yields and ten-year Treasury bond yields since 1955. One-year Treasury yields are depicted in red and ten-year Treasury yields in blue. Inversions in the yield curve, when one-year Treasury yields were greater than ten-year Treasury yields, are identified with green boxes. Recessions are indicated on the graph with grey shading. For reference, S&P 500 Index data during the same time frame is included. FIG. 4 illustrates that Treasury bond interest rate yield curve inversions have historically been a leading indicator of recessions within 12-18 months, with a few false signals. Treasury bond interest rate yield data is added to the system as it is released, smoothed, and analyzed for inversions in real time.

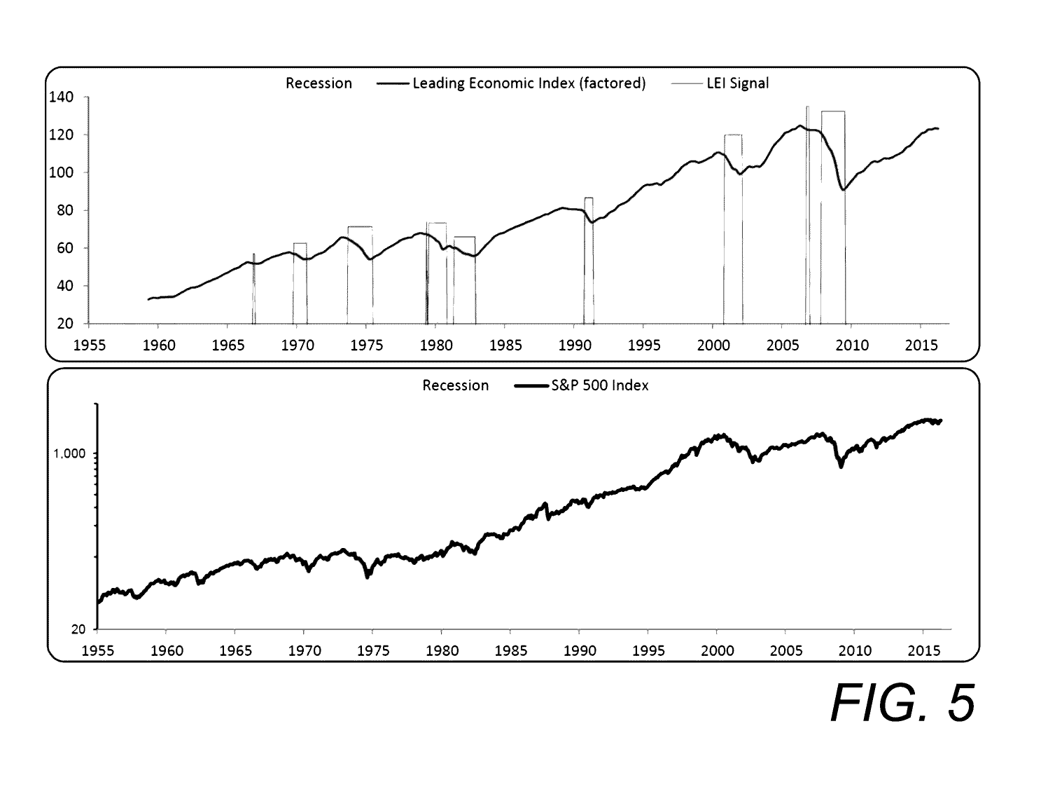

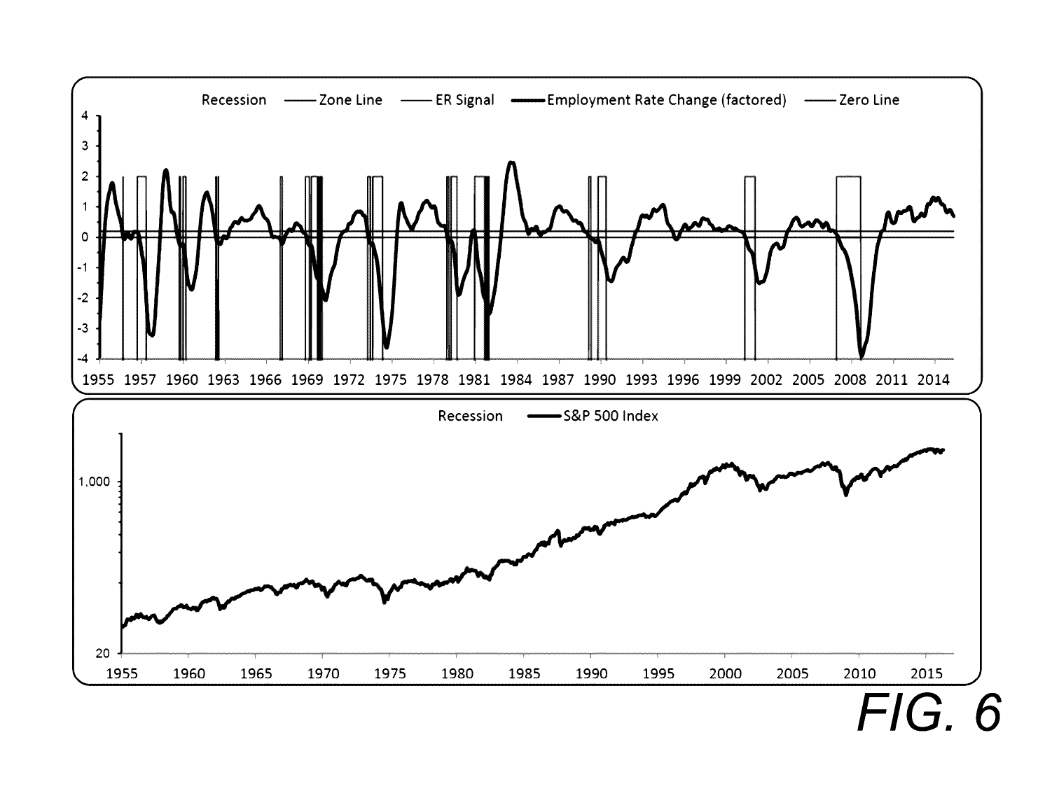

FIG. 5 illustrates a graph of smoothed Leading Economic Index data since 1958 with green boxes indicating when the Leading Economic Index recession-like indicator trigger or signal was triggered and grey shading indicating recessions. The S&P 500 Index data during the same time frame is included for reference. Leading Economic Index raw data is obtained from the Conference Board. That data is smoothed using a three-month moving average, lessening the effect of later revisions, and the data is put into graph form. Alternatively, different moving averages could be used. The data is analyzed for depth of drops, duration of drops, and diffusion of individual factors dropping at the same time. Drops in the Leading Economic Index, using smoothed data and analyzing depth, duration, and diffusion, are set as a recession-like condition indicator signal or trigger. FIG. 5 illustrates that the Leading Economic Index indicator signal has historically been a good leading indicator of recessions, with some false signals and one late signal. Leading Economic Index data is added to the system as it is released, smoothed, and analyzed for the Leading Economic Index indicator signal in real time.

FIG. 6 shows a graph of the employment rate of change since 1955 with green boxes indicating when the employment rate recession-like indicator trigger or signal was triggered and grey shading indicating recessions. The S&P 500 Index data during the same time frame is included for reference. U.S. employment and unemployment data is released by the Bureau of Labor Statistics weekly. The employment data is smoothed with a 10 week moving average and converted into a seasonally adjusted employment rate of change relative to the previous year's seasonally adjusted employment rate. Alternatively, different moving averages could be used. Historically, a seasonally adjusted employment rate that is falling from the previous year has been an indicator of an increased risk of recession. An employment rate recession-like indicator signal or trigger is set based on a negative change in the employment rate from the previous year and taking into account a predetermined duration of employment rate decrease, a predetermined speed and duration of unemployment increase, and analysis of moving average crossovers. FIG. 6 illustrates that the employment rate indicator signal has historically been a good indicator of recessions, with some false signals and some late signals. It is noted that these signals have shown to be more accurate since 1981 and may reflect a change in attitude by employers to more quickly reduce their labor force in the early signs of a slowdown in their business. Employment data is added to the system as it is released, smoothed, and analyzed for the employment rate indicator signal in real time.

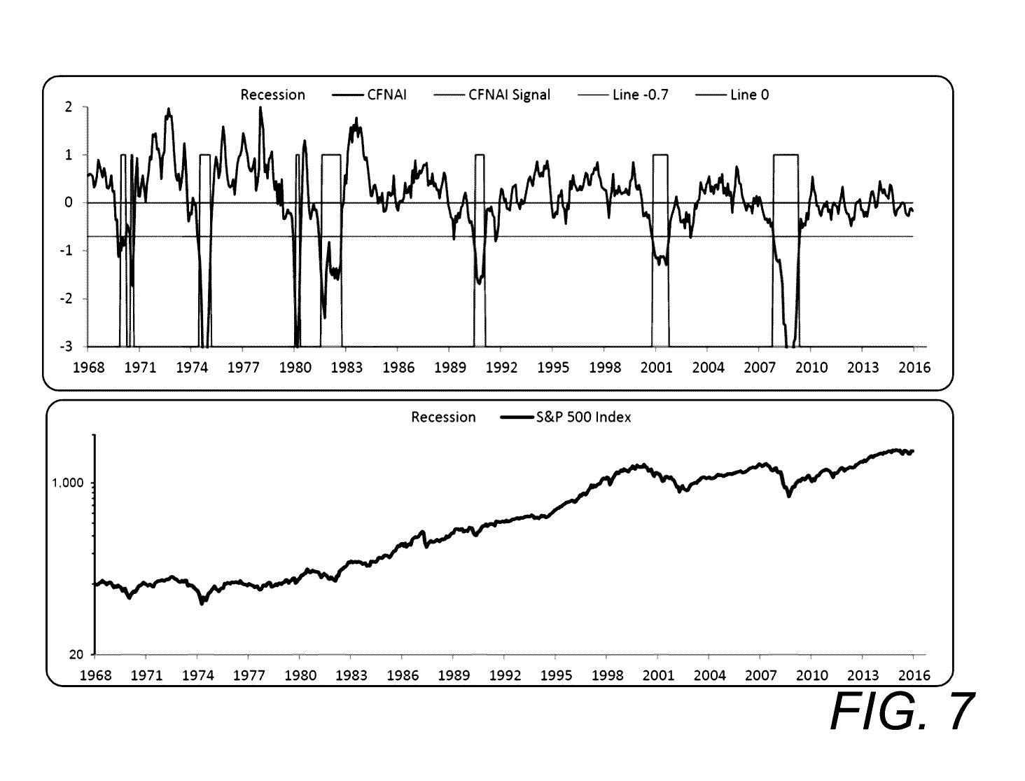

FIG. 7 shows a graph of the Chicago Federal Reserve National Activity Index (CFNAI) data dating back to 1968 with green boxes indicating when the CFNAI recession-like indicator trigger or signal was triggered and grey shading indicating recessions. The S&P 500 Index data during the same time period is included for reference. The CFNAI is produced as a weighted average of 85 monthly economic indicators, and it is designed to have an average value of zero. Based on the weighted averages, a CFNAI value of —0.7 or lower is intended to indicate a strong potential for recession. Data is obtained from the Chicago Federal Reserve, smoothed with moving averages, and graphed. The CFNAI indicator signal or trigger is set for a value of −0.7 or lower. FIG. 7 illustrates that the CFNAI indicator signal has historically been a good indicator of recessions, with some late signals. CFNAI data is added to the system as it is released, smoothed, and analyzed for the CFNAI indicator signal in real time.

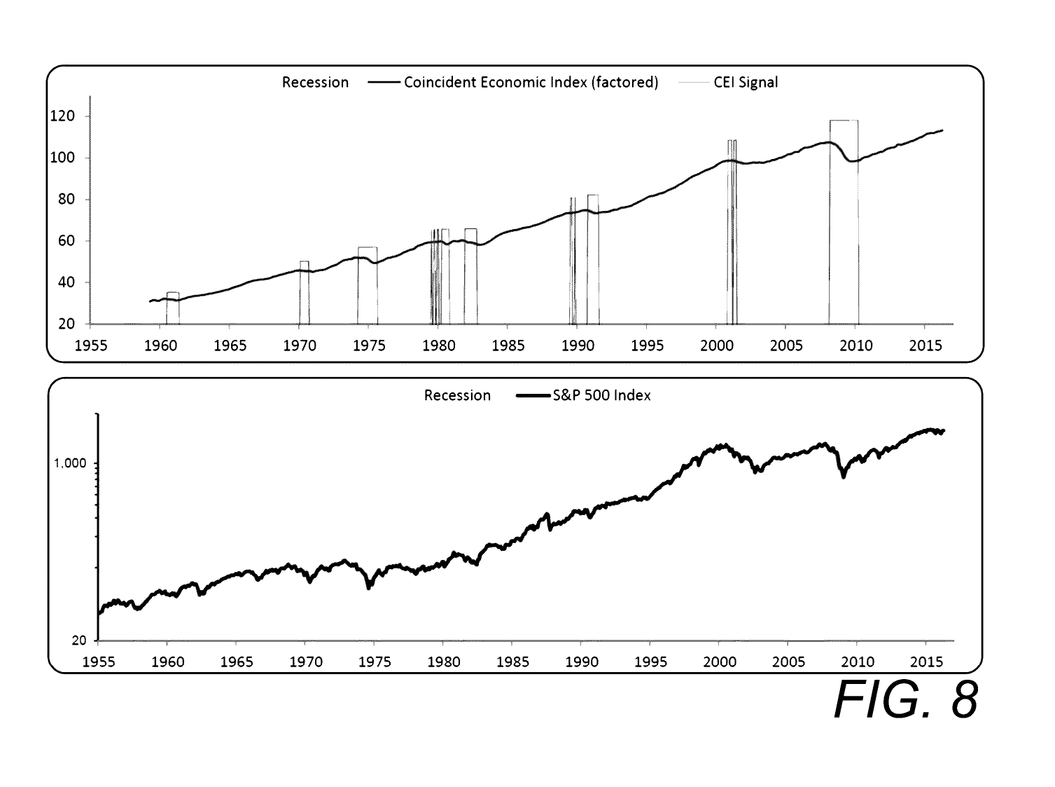

FIG. 8 shows a graph of smoothed Coincident Economic Index data since 1958 with green boxes indicating when the Coincident Economic Index recession-like indicator trigger or signal was triggered and grey shading indicating recessions. The S&P 500 Index data during the same time frame is included for reference. Coincident Economic Index raw data is obtained from the Conference Board. That data is smoothed using a three-month moving average, lessening the effect of later revisions, and the data is put into graph form. Alternatively, different moving averages could be used. The data is analyzed for depth of drops, duration of drops, and diffusion of individual factors dropping at the same time. Drops in the Coincident Economic Index, using smoothed data and analyzing depth, duration, and diffusion, are set as a recession-like condition indicator signal or trigger. FIG. 8 illustrates that the Coincident Economic Index indicator signal has generally been a good indicator of recessions, with some false signals. Coincident Economic Index data is added to the system as it is released, smoothed, and analyzed for the Coincident Economic Index indicator signal in real time.

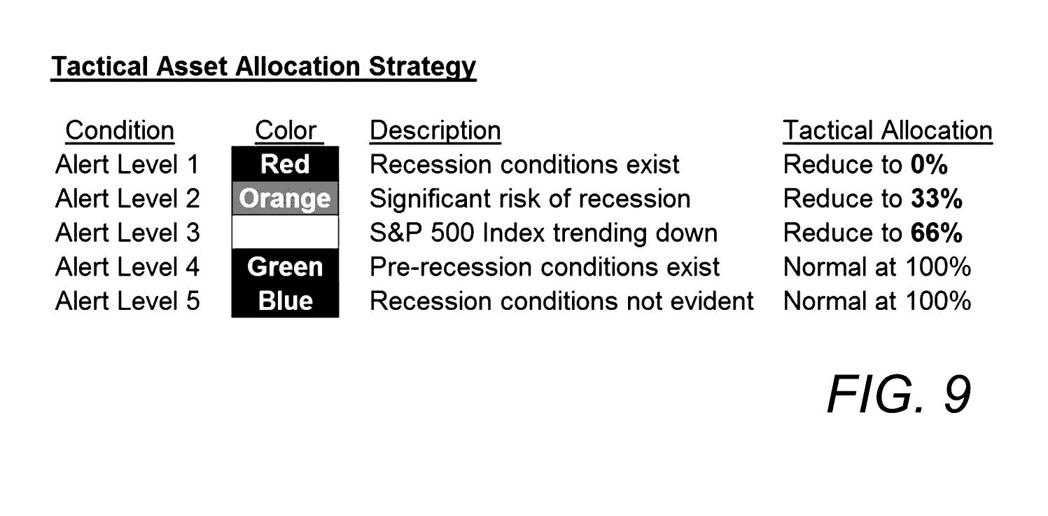

Using a combination of five recession-like condition indicator signals from five different economic data sets decreases the effect of false signals and reinforces the likelihood of recession-like conditions being present. In a preferred embodiment, the aforementioned five recession-like condition indicator signals or triggers are utilized within a tactical asset allocation system and method having five different alert levels. FIG. 9 illustrates an embodiment of a tactical asset allocation strategy of the present invention with five alert levels, alert level five being the lowest alert level and alert level one the highest alert level. In this embodiment, the alert levels are color-coded in the same manner as the U.S. Armed Forces DEFCON system: blue signifies alert level 5, green signifies alert level 4, yellow signifies alert level 3, orange signifies alert level 2, and red signifies alert level 1. In alternative embodiments, different color-coding or no color-coding could be used. In the embodiment depicted by FIG. 9, at alert level 5, recession conditions are not evident, and 100% of tactical assets are allocated in a normal, diversified mix of tactical equity assets. Alert level 4 occurs when pre-recession conditions are determined to exist. In a preferred embodiment, this occurs when two or more out of five recession-like condition indicator signals are triggered. At alert level 4, tactical assets are kept invested 100% in tactical equity assets, but the investment markets are closely monitored. If at alert level 4 and the investment markets trend downward a predetermined amount, alert level 3 is triggered. In this embodiment, the S&P 500 Index is monitored for systematic trends of the investment markets, and moving average crossovers are used to determine the direction the S&P 500 Index is trending. In a preferred embodiment, crossovers of the 25-day and 85-day moving averages are used in analyzing whether the S&P 500 Index is trending up or down, but variations in the moving averages may be used. Alternatively, other broad market equity indexes may be used and monitored to identify systematic trends of the investment markets. At alert level 3, tactical equity assets are reduced to 66%. The other 33% of tactical assets are shifted to more stable fixed income investments. If the investment markets continue to trend down a predetermined amount, there is a significant risk of recession, and alert level 2 is triggered. At alert level 2, tactical equity assets are reduced to 33%, shifting another 33% of tactical assets into fixed income investments. In a preferred embodiment, the predetermined continued drop is an additional 0.5% drop in the smoothed S&P 500 Index, however, this predetermined drop may be a different value. If the investment markets keep trending downward another predetermined amount, alert level 1 is triggered meaning recession conditions exist. At alert level 1, tactical equity assets are reduced to zero, moving the final 33% of tactical assets into fixed income investments. In a preferred embodiment, the predetermined drop is an additional 0.5% drop in the smoothed S&P 500 Index. If the investment markets trend upward by predetermined amounts, lower alert levels are triggered and tactical assets are reallocated back into tactical equity assets accordingly.

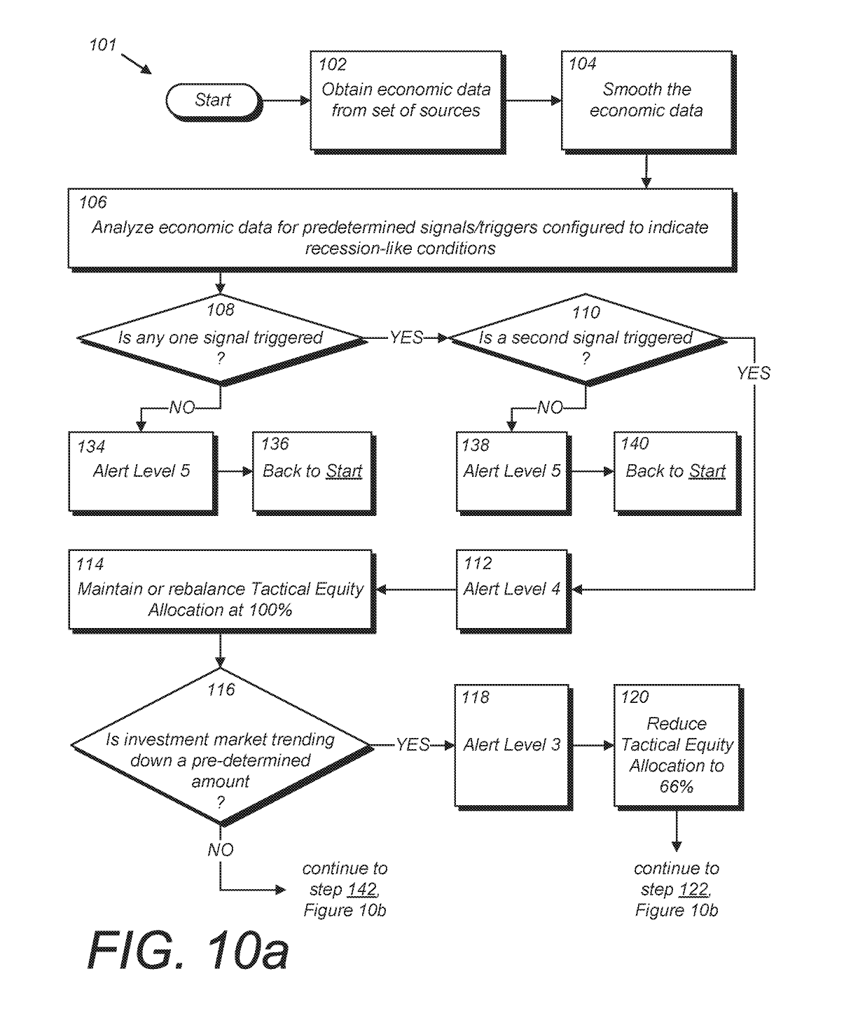

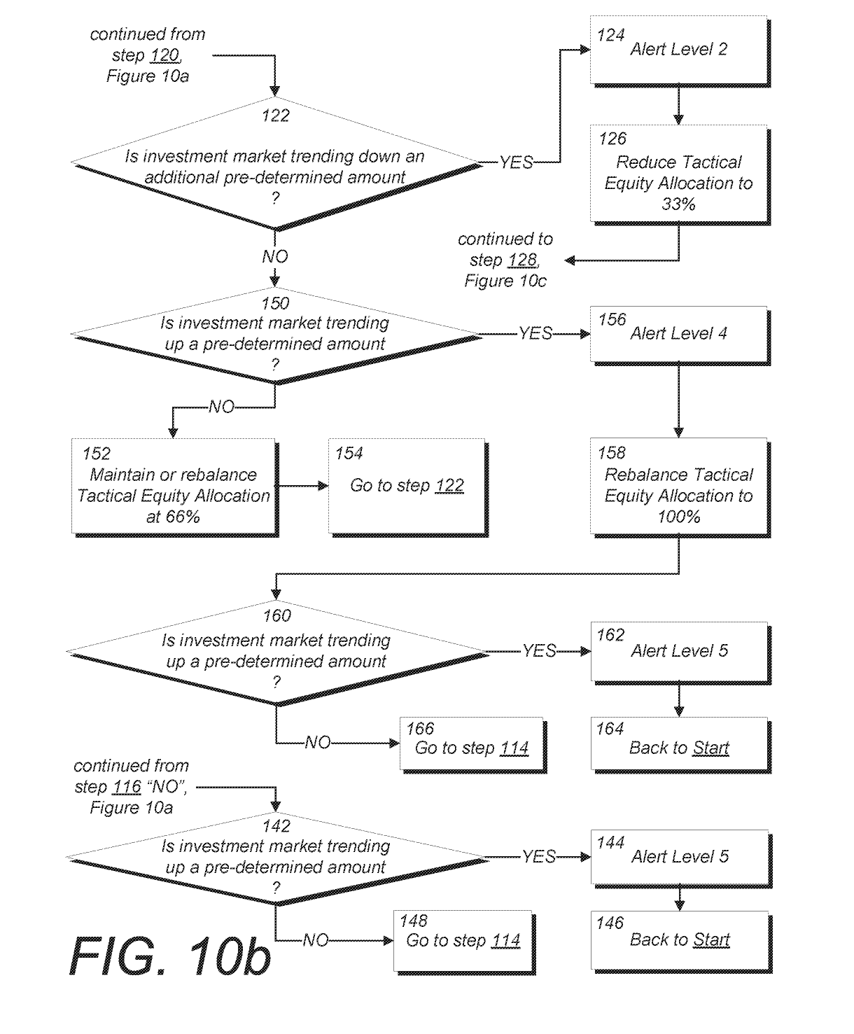

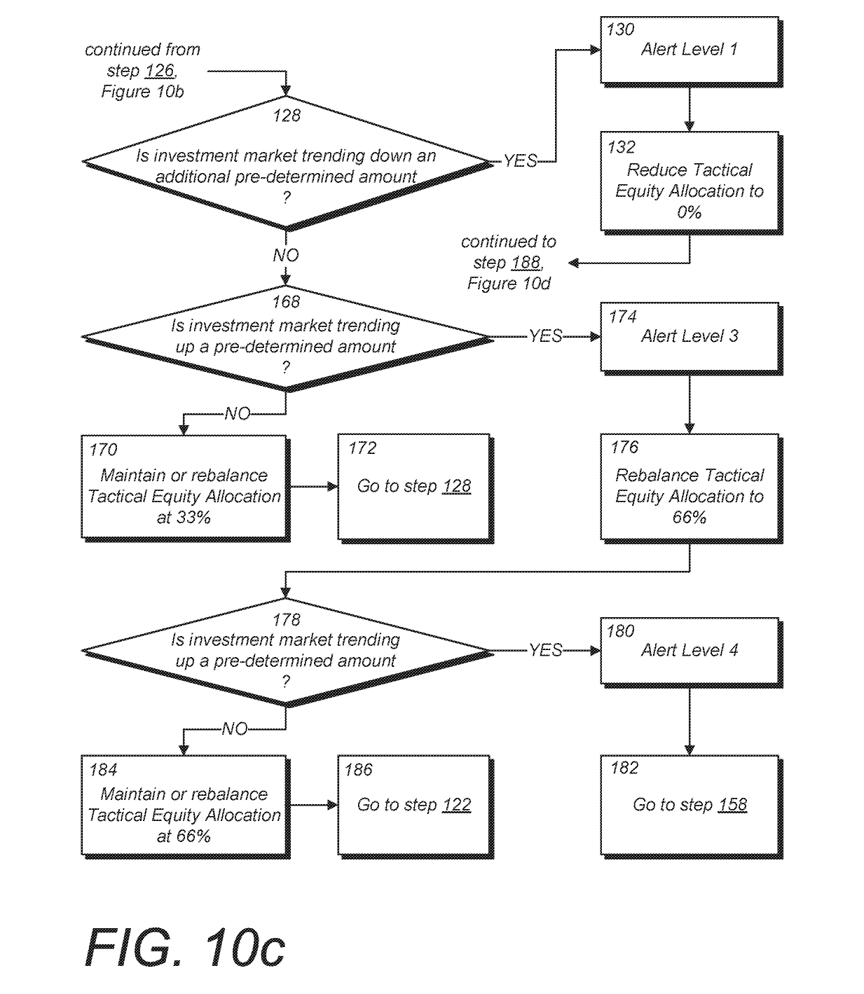

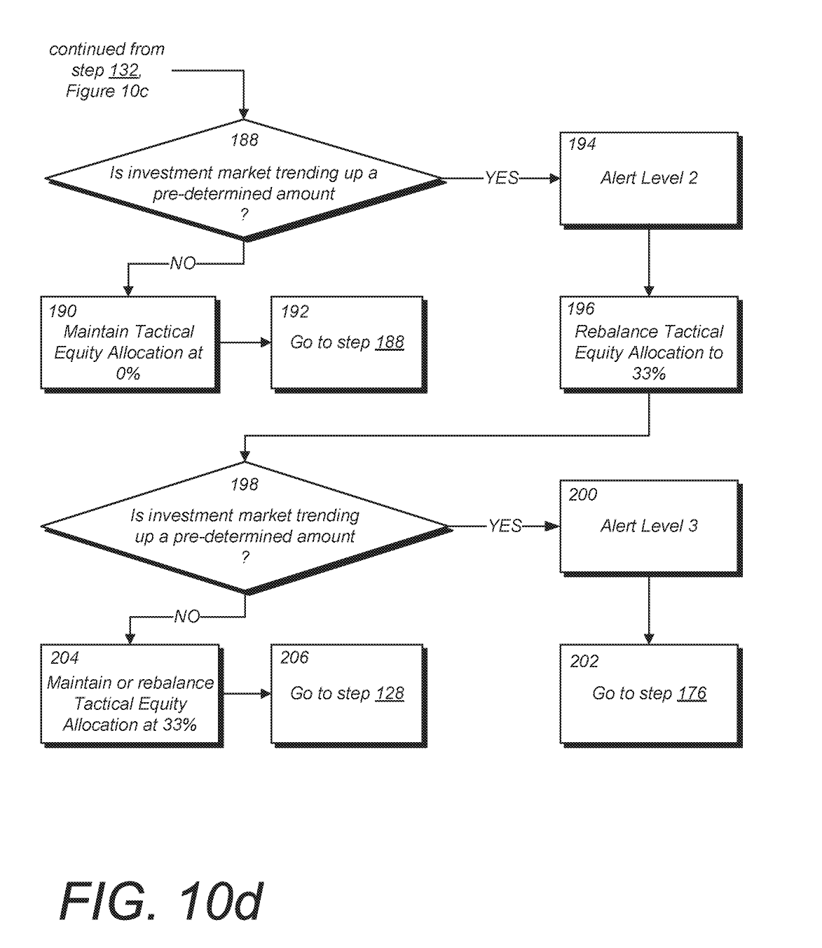

FIGS. 10a-10c are a flowchart illustrating a tactical asset allocation system and method 101 which embodies the present invention. In this embodiment, the tactical asset allocation system and method 101 includes five alert levels, and assets are allocated depending on the current alert level and the trends of the investment markets. At step 102, economic data is obtained from a set of multiple economic data sources. In a preferred embodiment, the sets of economic data are Treasury bond interest rate yield data, Leading Economic Index data, employment data, CFNAI data, and Coincident Leading Index data. At step 104, the economic data is smoothed using moving averages. The moving averages lessen the effects of post-release revisions to the data and help to identify overall trends in the data. At step 106, the smoothed economic data is analyzed for predetermined indicator signals or triggers configured for indicating recession-like conditions. In the preferred embodiment, the indicator signals or triggers are comprised of the Treasury bond interest rate yield inversion indicator signal, the Leading Economic Index indicator signal, the employment rate indicator signal, the CFNAI indicator signal, and Coincident Leading Index indicator signal, each configured as described above. At step 108, it is determined whether any one of the five indicator signals is triggered. If not, the system remains at alert level 5 at step 134 and the user goes back to the start at step 136. If any signal is triggered at step 108, then it is determined if a second signal is triggered at step 110. If not, the system remains at alert level 5 at step 138, and the user goes back to the start at step 140. If a second signal is triggered at step 110, alert level 4 is triggered at step 112.

At alert level 4, tactical equity assets are maintained or rebalanced at 100% at step 114. From there, it is determined whether the investment market is trending down a predetermined amount at step 116. In a preferred embodiment, the systematic trends of the investment markets are monitored using smoothed S&P 500 Index data and moving average crossovers. The preferred moving averages are the 25-day and 85-day moving averages of the S&P 500 Index. The predetermined amount at step 116, in the preferred embodiment, is a 25-day moving average and an 85-day moving average crossover trending downward for the S&P 500 Index. Box 142a on FIG. 10a continues to box 142b on FIG. 10b, and box 118a on FIG. 10a connects to box 118b on FIG. 10b. If the investment market is not trending down a predetermined amount at step 116, it is determined whether the investment market it trending up a predetermined amount at step 142. If the investment market is not trending up a pre-determined amount at step 142, meaning the investment market is neither trending down or up predetermined amounts, the user goes back to step 114 from step 148, maintaining tactical equity assets at 100% and repeating the process of determining the trends of the investment market. If the investment market is trending up a predetermined amount at step 142, the alert level is moved to alert level 5 at step 144, and the user goes back to the start at step 146.

If the investment market is trending down the predetermined amount at step 116, alert level 3 is triggered at step 118. At alert level 3, tactical equity asset allocation is reduced to 66% at step 120. Then, it is determined if the investment market is trending down an additional predetermined amount at step 122. In the preferred embodiment the predetermined additional amount is the smoothed S&P 500 Index trending down an additional 0.5%. If the investment market is not trending down the additional predetermined amount at step 122, it is determined whether the investment market is trending up a predetermined amount at step 150. If the investment market is not trending up a predetermined amount at step 150, meaning the investment market is neither trending up or down predetermined amounts, tactical equity assets are maintained or rebalanced at 66% at step 152 and the user goes back to step 122 from step 154, repeating the process of determining the trends of the investment market.

If the investment market is trending up a predetermined amount at step 150, the alert level is moved to alert level 4 at step 156, and tactical equity assets are rebalanced or increased to 100% at step 158. From there, it is determined whether the investment market is trending up an additional predetermined amount at step 160. If the investment market is not trending up the predetermined amount at step 160, the user circles back to step 114 from step 166, where tactical equity assets are maintained at 100% and the process of determining trends of the investment market is repeated. If the investment market is trending up a predetermined amount at step 160, the alert level is changed to alert level 5 at step 162, and the user goes back to the start at step 164.

At step 122, if the investment market is trending down the additional predetermined amount—the smoothed S&P 500 Index down an additional 0.5% in the preferred embodiment—alert level 2 is triggered at step 124. At alert level 2, tactical equity assets are reduced to 33% at step 126. Box 128b on FIG. 10b continues to box 128c on FIG. 10c. Next, it is determined if the investment market is trending down an additional predetermined amount at step 128. In the preferred embodiment, the predetermined amount at step 128 is the smoothed S&P 500 Index trending down an additional 0.5%. If the investment market is not trending down an additional predetermined amount at step 128, it is determined whether the investment market is trending back up a predetermined amount at step 168. If the investment market is not trending up a predetermined amount at step 168, tactical equity assets are maintained or rebalanced at a 33% allocation at step 170, and the user goes back to step 128 from step 172, repeating the process of determining the trends of the investment market.

If the investment market, at step 168, is trending up a predetermined amount, the alert level is changed to alert level 3 at step 174, and tactical equity assets are rebalanced or increased to 66% at step 176. Then, it is determined if the investment market is trending up an additional predetermined amount at step 178. If the investment market is trending up the additional predetermined amount at step 178, the alert level is moved to alert level 4 at step 180, and the user goes to step 158 from step 182, where tactical equity assets are rebalanced or increased to 100%, followed by continued monitoring of the investment market. At step 178, if the investment market is not trending up an additional predetermined amount, tactical equity assets are maintained or rebalanced at 66% at step 184, and the user goes back to step 122, repeating the process of determining the trends of the investment market.

If the investment market is trending down the additional predetermined amount at step 128, alert level 1 is triggered at step 130. At alert level 1, tactical equity assets are reduced to zero at step 132. At step 188, it is determined if the investment market is trending back up a predetermined amount. If the investment market is not trending up a predetermined amount at step 188, tactical equity asset allocation is maintained at zero at step 190. Then, the user goes back to step 188 from step 192, continuing to monitor whether the investment market is trending up a predetermined amount.

If the investment market is trending up the predetermined amount at step 188, the alert level is changed to alert level 2 at step 194, and tactical equity assets are rebalanced or increased to 33% at step 196. At step 198, it is determined whether the investment market is trending up an additional predetermined amount. If the investment market, at step 198, is not trending up the additional predetermined amount, tactical equity assets are maintained at 33% at step 204, and the user goes back to step 128 from step 206, repeating the process of determining the trends of the investment market. If the investment market, at step 198, is trending up the additional predetermined amount, the alert level is changed to alert level 3 at step 200, and the user goes to step 176 from step 202, where the tactical equity assets are rebalanced or increased to 66%, followed by continued monitoring of the investment market.

The flowchart shown in FIGS. 10a-10c illustrates that the tactical asset allocation system and method 101 creates a continuous loop of investment market analysis and changes in tactical equity asset allocation depending on the trends of the investment market. Predetermined recession-like indicator signals using economic data are utilized in moving from alert level 5 to alert level 4. Investment market trends dictate the other changes up and down alert levels and their corresponding tactical asset reallocations, until the alert level is moved back to alert level 5.

It is to be understood that the invention can be embodied in various forms, and is not to be limited to the examples discussed above. The range of components and configurations which can be utilized in the practice of the present invention is virtually unlimited.

Having thus described the disclosed subject matter, what is claimed as new and desired to be secured by Letters Patent is:

1. An algorithm-based system for managing data based on predefined variable conditions, which system includes:
multiple, progressive levels of predefined conditions varying over time;
each said condition being defined by an index including quantities varying over time;
said time-varying index quantities comprising a systematic data index and multiple data sets each including a predetermined indicator trigger;
said algorithm reclassifying said condition levels based on said time-varying index quantities defined as:
if any two or more of said multiple data set indicator triggers are met, reclassifying from the lowest alert condition level to the next progressive condition level, and if classified at any condition level other than the lowest alert condition level, reclassifying to the next higher alert condition level if said systematic data index is trending downward a predetermined amount and reclassifying to the next lower alert condition level if said systematic data index is trending upward a predetermined amount; and
said time-varying index quantities being averaged on a rolling basis according to the algorithm:
the sum of time-varying index quantities for a predetermined time period divided by said time period.

2. The algorithm-based system for managing data according to claim 1, wherein:
said systematic data index comprises broad market equity index data;
said multiple data sets comprise Treasury bond interest rate yield curve data, Leading Economic Index data, employment trends data, Chicago Federal Reserve National Activity Index data, and Coincident Economic Index data; and
said predetermined indicator triggers comprise an inversion in Treasury bond interest rate yield curves, a decrease in the Leading Economic Index, a decrease in employment rate from the previous year's employment rate, a Chicago Federal Reserve National Activity Index value −0.7 or below, and a decrease in the Coincident Economic Index.

3. The algorithm-based system for managing data according to claim 2, wherein said predetermined indicator triggers are configured for including analysis of the duration, depth, and diffusion of said data to lessen risk of false signals.

4. The algorithm-based system for managing data according to claim 2, wherein said broad market equity index data comprises smoothed S&P 500 Index data.

5. The algorithm-based system for managing data according to claim 3, wherein said predetermined amount of downward or upward trend comprises 0.5% of said smoothed S&P 500 Index data.

6. The algorithm-based system for managing data according to claim 1, wherein:
said multiple, progressive condition levels comprise five condition levels;
at the lowest and second-lowest alert condition levels, tactical investment assets are configured to be allocated 100% in equity investments;
at the third alert level, tactical investment assets are configured to be allocated 66% in equity investments and 33% in fixed income investments;
at the second-highest alert level, tactical investment assets are configured to be allocated 33% in equity investments and 66% in fixed income investments; and
at the highest alert level, tactical investment assets are configured to be allocated 100% in fixed income investments.

7. A method of allocating investment assets comprising:
obtaining sets of economic data;
smoothing said economic data using moving averages;
setting multiple predetermined indicator triggers each configured to suggest recession-like conditions;
analyzing said smoothed economic data for said indicator triggers;
determining whether multiple of said indicator triggers have been met;
if multiple of said indicator triggers are met, closely monitoring the investment markets;
determining if the investment markets are trending downward; and
if multiple of said indicator triggers are met and the investment markets are trending downward, allocating tactical assets into fixed income investments in stages until the investment markets trend upward.

8. The method according to claim 7, wherein:
said allocating tactical assets into fixed income investments in stages comprises allocating a first third of tactical assets into fixed income when the investment markets trend downward, allocating a second third of tactical assets into fixed income if the investment markets trend downward an additional predetermined amount, and allocating a final third of tactical assets into fixed income if the investment markets trend downward an additional predetermined amount.

9. The method according to claim 8, wherein:
said additional predetermined amount comprises an additional 0.5%.

10. The method according to claim 7, wherein:
said sets of economic data comprise five economic data sets.

11. The method according to claim 10, wherein:
said five economic data sets comprising Treasury bond interest rate yield curve data, Leading Economic Index data, employment trends data, Chicago Federal Reserve National Activity Index data, and Coincident Economic Index data.

12. The method according to claim 7, further comprising the steps of:
determining optimized moving averages for monitoring the investment markets;
wherein said closely monitoring the investment markets comprises closely monitoring the S&P 500 Index; and
using moving average crossovers in analysis of whether the investment markets are trending downward or upward.

13. The method according to claim 7, wherein:
said analysis of said smoothed economic data includes analysis of the duration, depth, and diffusion of said data.

14. The method according to claim 11, wherein:
said multiple predetermined indicator triggers comprise an inversion in Treasury bond interest rate yield curves, a decrease in the Leading Economic Index, a decrease in employment rate from the previous year's employment rate, a Chicago Federal Reserve National Activity Index value −0.7 or below, and a decrease in the Coincident Economic Index.

15. A system for identifying economic trends and allocating tactical investment assets comprising:
a database of sets of economic data configured to be continually updated with newly-released data;
wherein said sets of economic data comprise Treasury bond interest rate yield curve data, Leading Economic Index data, employment trends data, Chicago Federal Reserve National Activity Index data, and Coincident Economic Index data;
wherein said economic data is configured to be smoothed using moving averages;
a predetermined indicator trigger for each set of economic data configured to suggest recession-like conditions;
wherein said predetermined indicator triggers comprise an inversion in Treasury bond interest rate yield curves, a decrease in the Leading Economic Index, a decrease in employment rate from the previous year's employment rate, a Chicago Federal Reserve National Index value −0.7 or below, and a decrease in the Coincident Economic Index;
wherein said predetermined indicator triggers are configured for including analysis of the duration, depth, and diffusion of said data to lessen risk of false signals;
broad market equity index data configured to be updated with newly-released data, smoothed using moving averages, and analyzed for trends using moving average crossovers;
five, progressive alert levels of economic conditions varying over time;
an algorithm for reclassifying said alert levels defined as:
if any two or more of said predetermined indicator triggers are met, reclassifying from the lowest alert level to the next progressive alert level, and if classified at any alert level other than the lowest alert level, reclassifying to the next higher alert level if said broad market equity index is trending downward a predetermined amount and reclassifying to the next lower alert level if said broad market equity index is trending upward a predetermined amount;
wherein said predetermined amount comprises 0.5% of said smoothed broad market equity index data;
wherein at said lowest and second-lowest alert levels, tactical assets are configured to be allocated 100% in equity investments;
wherein at said third alert level, tactical assets are configured to be allocated 66% in equity investments and 33% in fixed income investments;
wherein at said second-highest alert level, tactical assets are configured to be allocated 33% in equity investments and 66% in fixed income investments; and
wherein at said highest alert level, tactical assets are configured to be allocated 100% in fixed income investments.

16. The system for identifying economic trends and allocating tactical investment assets according to claim 15, wherein said broad market equity index data comprises S&P 500 Index data.
